(19) United States
(12) Patent Application Publication
(10) Pub. No.: US 2025/0067472 A1
(43) Pub. Date: Feb. 27, 2025

(54) PIPE AND WATER HEATER INCLUDING THE SAME

(71) Applicant: KYUNGDONG NAVIEN CO., LTD., Gyeonggi-do (KR)

(72) Inventors: Kyu Hong LEE, Seoul (KR); Choong Gon LEE, Seoul (KR)

(73) Assignee: KYUNGDONG NAVIEN CO., LTD., Gyeonggi-do (KR)

(21) Appl. No.: 18/784,217

(22) Filed: Jul. 25, 2024

(30) Foreign Application Priority Data
Aug. 22, 2023 (KR) 10-2023-0109574

(51) Int. Cl. F24H 9/02; F24H 9/14

(52) U.S. Cl. CPC F24H 9/02; F24H 9/14

(57) ABSTRACT

A pipe according to the present disclosure includes a body portion provided with a seating section having a straight profile extending in a first direction and extending in a second direction that is one direction perpendicular to the first direction when cut along a plane perpendicular to the first direction, wherein the body portion passes in the first direction to define a hollow.

### CROSS-REFERENCE TO RELATED APPLICATION

This application claims the benefit of priority to Patent Application No. 10-2023-0109574, filed in the Korean Korean Intellectual Property Office on Aug. 22, 2023, the entire contents of which are incorporated herein by reference.

### TECHNICAL FIELD

The present disclosure relates to a pipe through which a fluid passes and a water heater including the same.

### BACKGROUND

A water heater r is a device that transfers heat generated by a combustion reaction to water and uses the heated water for heating or hot water supply. A process of introducing water, heating the introduced water, and then discharging the heated water is performed through the water heater. That is, a boiler, a hot water supplier, or the like may be implemented by the water heater.

The combustion reaction may occur in a burner, and in order for the burner to cause the combustion reaction, air and fuel are required. The fuel may be in the form of a gas. The fuel and the air are mixed in a mixing chamber to form a mixture, and thus a state in which a frame is well formed is provided. Further, after the mixture is distributed through a distribution plate or the like, ignition occurs, and thus the frame may be generated together with the combustion reaction. A burner that causes the combustion reaction in this manner is called a premix burner.

The fuel for the combustion reaction may be transferred to the burner through a gas pipe. The gas pipe may have an extending portion even inside a case of the boiler. A pipe constituting the gas pipe is generally formed in a hollow cylindrical shape. A gas switch should be fastened to the circular pipe, but it is difficult to stably fasten the switch to a sufficiently thick portion due to an outer wall having a curved shape, and thus there is a risk of gas leakage.

Further, the gas pipe may have an extending portion even outside the case of the boiler. Because a rotational force is applied to a portion of the gas pipe positioned outside the case to connect the gas pipe to a structure inside the case, there is a risk that the gas pipe and various components connected to the gas pipe may be damaged while being rotated.

### SUMMARY

The present disclosure has been made to solve the above-mentioned problems occurring in the prior art while advantages achieved by the prior art are maintained intact.

An aspect of the present disclosure provides a pipe that easily couples a gas switch from the outside and does not easily rotate when coupled to a support, and a water heater including the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, there is provided a pipe including a body portion provided with a seating section having a straight profile extending in a first direction and extending in a second direction that is one direction perpendicular to the first direction when cut along a plane perpendicular to the first direction, wherein the body portion passes in the first direction to define a hollow.

According to another aspect of the present disclosure, there is provided a water heater including a burner that causes a combustion reaction from fuel, a heat exchanger that heats water using heat generated by the combustion reaction caused by the burner, a gas provider including a gas valve coupled to the burner to control flow of a gas transferred to the burner to be used as fuel and a gas pipe coupled to the gas valve to transfer the gas to the gas valve, and a case in which the burner, the heat exchanger, and the gas valve are embedded and which is coupled to the gas pipe, wherein the gas pipe includes a body portion which extends in a left-right direction, in which a hollow is formed such that the gas passes therethrough, and which has a straight profile on an upper side thereof, the straight profile extending in a front-rear direction that is one direction perpendicular to the left-right direction when cut along a plane perpendicular to the left-right direction.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating an exterior of a water heater according to an embodiment of the present disclosure;

FIG. 2 is a perspective view illustrating an open portion of the water heater according to the embodiment of the present disclosure;

FIG. 3 is a perspective view illustrating a gas provider of the water heater according to the embodiment of the present disclosure;

FIG. 4 is a view illustrating the gas provider of the water heater and a surrounding component thereof together with a cross section of the gas provider according to the embodiment of the present disclosure;

FIG. 5 is a perspective view illustrating a state in which a gas valve and a transfer pipe are removed from the gas provider of the water heater according to the embodiment of the present disclosure;

FIG. 6 is a perspective view illustrating a gas pipe of the water heater according to the embodiment of the present disclosure;

FIG. 7 is a cross-sectional view along line B-B′ of FIG. 6;

FIG. 8 is a cross-sectional view along line C-C′ of FIG. 6.

FIG. 9 is a perspective view illustrating a basic pipe for forming a gas pipe of the water heater according to the embodiment of the present disclosure;

FIG. 10 is a perspective view illustrating a state in which the gas pipe is formed by processing the basic pipe according to the embodiment of the present disclosure;

FIG. 11 is a perspective view illustrating a state in which components for forming the gas provider are connected to the gas pipe according to the embodiment of the present disclosure; and

FIG. 12 is a cross-sectional view illustrating packing and the gas pipe in contact with the packing according to the embodiment of the present disclosure.

### DETAILED DESCRIPTION

Hereinafter, some embodiments of the present disclosure will be described in detail with reference to the exemplary drawings. In adding reference numerals to components of each drawing, it should be noted that identical or equivalent components are designated by an identical numeral even when they are displayed on other drawings. Further, in describing the embodiment of the present disclosure, a detailed description of the related known configuration or function will be omitted when it is determined that it interferes with the understanding of the embodiment of the present disclosure.

Further, in the description of components of the embodiments of the present disclosure, the terms such as first, second, A, B, and (a) may be used. These terms are merely intended to distinguish one component from other components, and the terms do not limit the nature, order, or sequence of the components. It should be understood that when one component “is connected to,” “communicates with,” “is coupled to,” or “is joined to” another component, the former may be directly connected or jointed to the latter or may “be connected to,” “communicate with,” “be coupled to,” or “be joined to” the latter with a third component interposed therebetween.

In the specification of the present disclosure, a front-rear direction, a vertical direction, and a left-right direction mean relative directions perpendicular to each other and are used for convenience of description. In the specification of the present disclosure, a first direction may be the front-rear direction, a second direction may be the left-right direction, and a third direction may be the vertical direction, but the first direction, the second direction, and the third direction are relative directions that are determined according to a state in which a pipe constituting a gas pipe 32 is disposed.

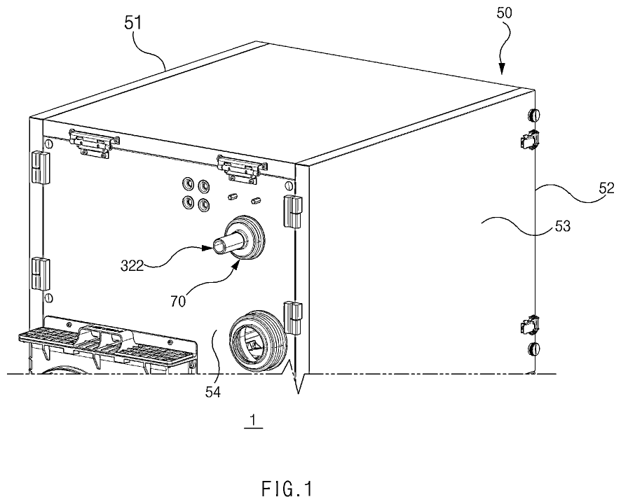

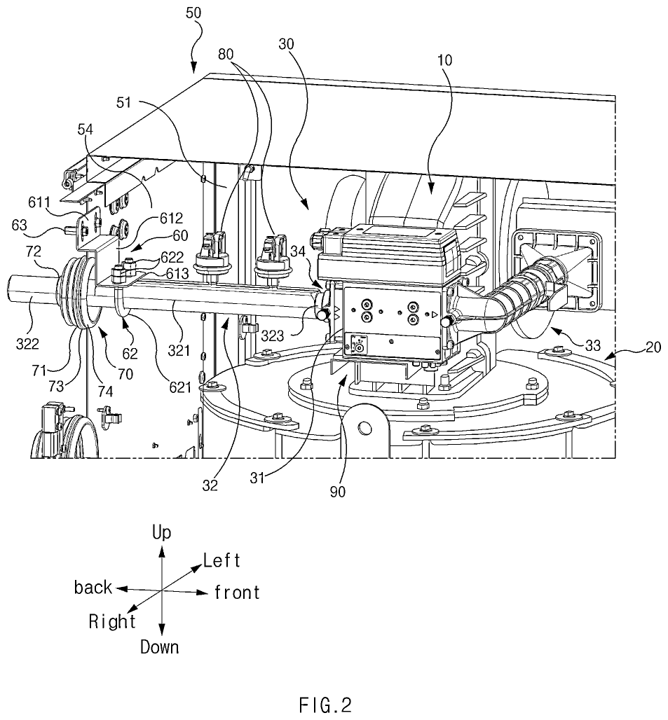

FIG. 1 is a perspective view illustrating an exterior of a water heater 1 according to an embodiment of the present disclosure. FIG. 2 is a perspective view illustrating an open portion of the water heater 1 according to the embodiment of the present disclosure.

Referring to the drawings, the water heater 1 according to the embodiment of the present disclosure includes a burner 10, a heat exchanger 20, a gas provider 30, and a case 50. The gas provider 30 according to the embodiment of the present disclosure includes a gas valve 31 and the gas pipe 32, and the gas pipe 32 is a pipe including a body portion 321.

The burner 10 is a device that causes a combustion reaction from fuel. The burner 10 may generate a premixture of the fuel and air and ignite the premixture to cause the combustion reaction. The burner 10 may have a distribution plate having a plurality of slits so that the premixture of the fuel and the air is distributed and discharged. The burner 10 may include a mat made of a metal fiber to cover the distribution plate and cause ignition. The burner 10 may include a spark plug that generates a spark around the distribution plate to cause the ignition.

The burner 10 may include a blower. The blower may pump the premixture of the fuel and the air supplied from the outside into a combustion chamber through the distribution plate. Thus, the blower may be connected to the gas provider 30 and may be connected to an air supply duct for receiving outside air. The blower may include a wing part that rotates to pump the air and a rotational part that generates a rotational driving force to rotate the wing part and transfers the generated rotational driving force to the wing part. The wing part may be a cased impeller. The rotational part may be a motor.

The premixture blown from the blower may pass through a backflow preventing damper and be transferred to the distribution plate. When a combustion gas flows back from the combustion chamber to the blower, the burner 10 may be broken down or the combustion gas may be discharged to the air through the air supply duct, and thus the backflow preventing damper may serve to prevent the backflow. The backflow preventing damper may be coupled to the distribution plate and an upper portion of the combustion chamber in a shape that extends in the vertical direction, may have an open/closed flap that is open while the premixture is supplied and is closed when the backflow occurs, but may prevent the backflow in various manners in addition to this manner.

The heat exchanger 20 is provided to heat water using heat generated by the combustion reaction caused by the burner 10. The heat exchanger 20 may be a fire tube heat exchanger in which heat is exchanged while the combustion gas flows through a fire tube passing through a tank filled with water, a fin-tube heat exchanger, or a plate heat exchanger, but the type of the heat exchanger 20 is not limited thereto.

The case 50 includes the burner 10, the heat exchanger 20, and the gas valve 31 in an interior thereof and is coupled to the gas pipe 32. The case 50 may have a plate-shaped upper plate that is perpendicular to the vertical direction and a lower plate spaced downward therefrom. The upper plate and the lower plate may have a rectangular shape. The case 50 may include a left plate 51, a right plate 53, a front plate 52, and a rear plate 54 connecting the upper plate and the lower plate. The left plate 51 and the right plate 53 may be formed in a plate shape that is perpendicular to the left-right direction and may be spaced apart from each other in the left-right direction. The front plate 52 and the rear plate 54 may be formed in a plate shape that is perpendicular to the front-rear direction and may be spaced apart from each other in the front-rear direction. The left plate 51 and the right plate 53 may be connected to the front plate 52 and the rear plate 54 to surround components of the water heater 1 together with the upper plate and the lower plate. A gas pipe through-hole passing through the gas pipe 32 may be formed in the rear plate 54, but the location of the gas pipe through-hole is not limited thereto.

The water heater 1 may include a bracket 60. The bracket 60 may be coupled to a position adjacent to the gas pipe through-hole on an inner surface of the rear plate 54 of the case 50. The bracket 60 may support a case fixing portion 322 of the gas pipe 32. That is, the gas pipe 32 may be supported on the case 50 by the bracket 60. The gas pipe 32 may include the case fixing portion 322. The case fixing portion 322 may pass through the gas pipe through-hole and be supported by the bracket 60.

The bracket 60 may include a bracket body part 61 and a support bolt part 62. The bracket body part 61 may be coupled to an upper portion of the gas pipe through-hole on the rear plate 54 of the case 50. The bracket body part 61 may be coupled to the inner surface of the rear plate 54 of the case 50 using a method such as bolting or riveting, but the coupling method is not limited thereto.

The bracket body part 61 may include a close contact portion 611 that is formed in a plate shape perpendicular to the front-rear direction and is in close contact with the rear plate 54, a body connecting portion 612 that extends forward from a lower end of the close contact portion 611, is bent to extend further downward, and is thus spaced forward from the rear plate 54, and a bolt connecting portion 613 which extends forward from a lower end of the body connecting portion 612 and to which the support bolt part 62 is coupled. The body connecting portion 612 may be formed to be bent in an “L” shape. The bolt connecting portion 613 may be placed in a position in which the bolt connecting portion 613 appropriately supports the gas pipe 32 in the front-rear direction.

The support bolt part 62 is a part which is coupled to the bracket body part 61 and on which the case fixing portion 322 is seated. The support bolt part 62 may include a “U”-shaped U bolt 621 and a support nut 622 coupled to both ends of the U bolt 621. In a state in which the case fixing portion 322 of the gas pipe 32 is placed inside the U bolt 621, both ends of the U bolt 621 may pass through a hole formed in the bolt connecting portion 613, the support nut 622 may be fastened to both ends of the U bolt 621 passing through the hole formed in the bolt connecting portion 613, and the bracket 60 may support the case fixing portion 322. A size of the hole formed in the bolt connecting portion 613 may be smaller than a size of the support nut 622. An inner surface of the bolt connecting portion 613 at a lower bent portion thereof is in contact with a seating section 3211, inner surfaces of a pair of portions of the bolt connecting portion 613 extending in the vertical direction are in contact with a side section 3212, and thus rotation of the gas pipe 32 may be prevented.

The bracket 60 fixedly supports the gas pipe 32 in the above-described manner, and thus the gas pipe 32 may not be deformed even by a rotational force that may be applied to the gas pipe 32, and a connection state with the gas valve 31 may be firmly maintained.

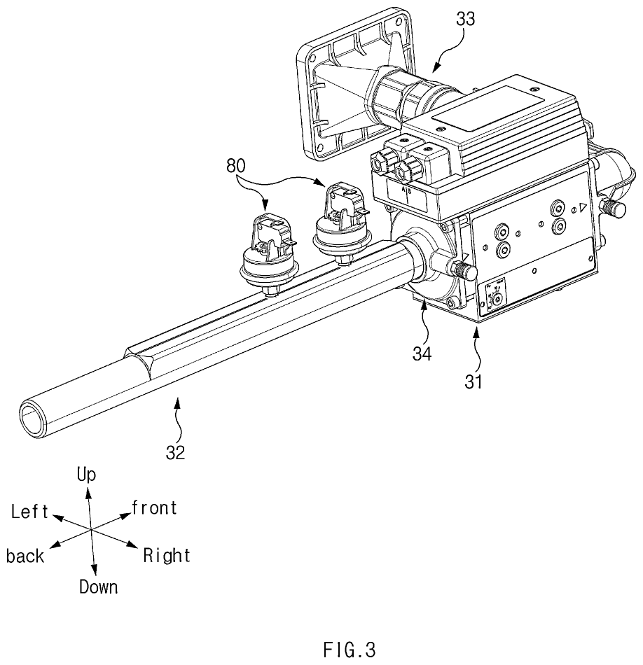

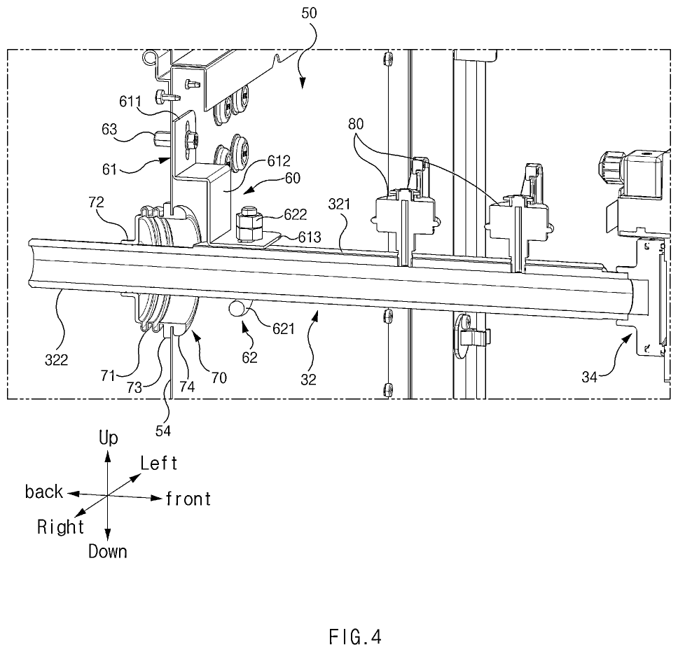

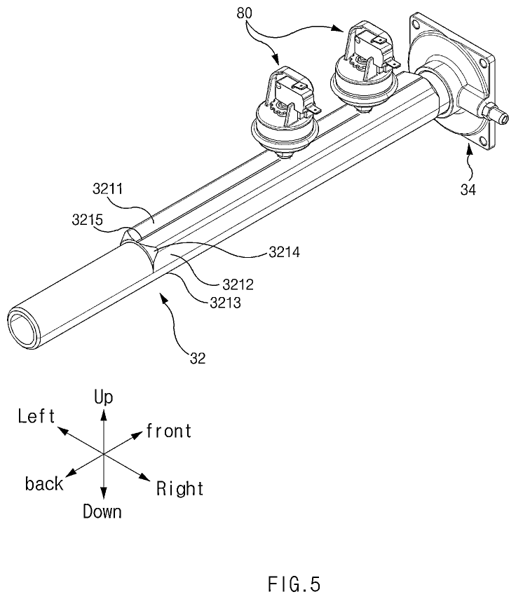

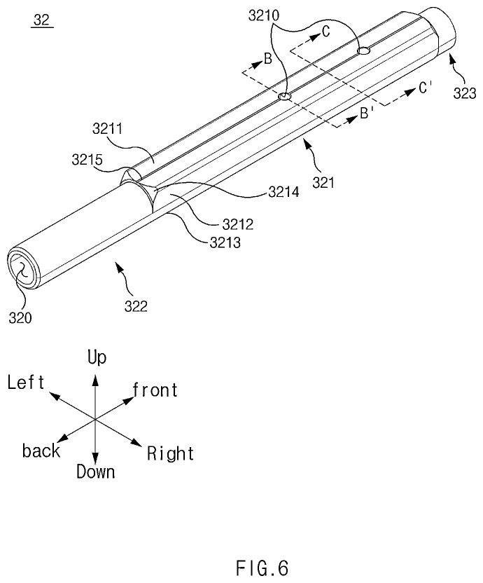

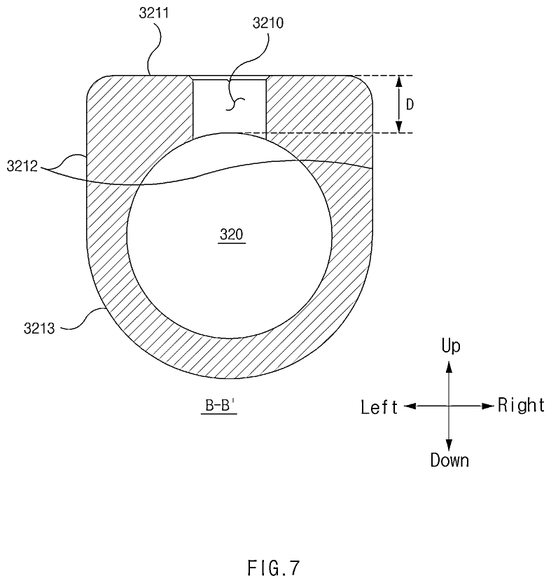

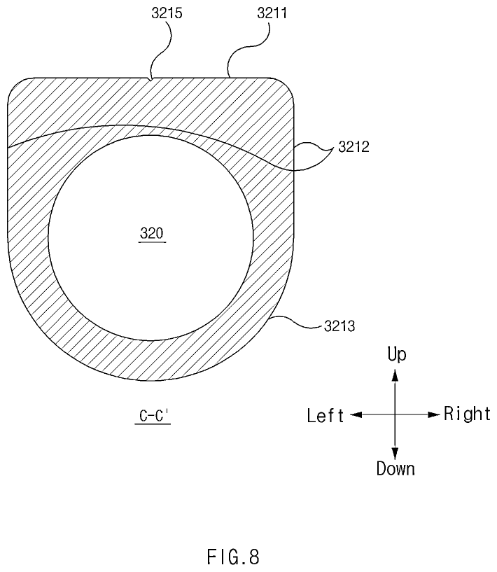

FIG. 3 is a perspective view illustrating the gas provider 30 of the water heater 1 according to the embodiment of the present disclosure. FIG. 4 is a view illustrating the gas provider 30 of the water heater 1 and a surrounding component thereof together with a cross section of the gas provider 30 according to the embodiment of the present disclosure. FIG. 5 is a perspective view illustrating a state in which the gas valve 31 and a transfer pipe 33 are removed from the gas provider 30 of the water heater 1 according to the embodiment of the present disclosure. FIG. 6 is a perspective view illustrating the gas pipe 32 of the water heater 1 according to the embodiment of the present disclosure. FIG. 7 is a cross-sectional view along line B-B′ of FIG. 6. FIG. 8 is a cross-sectional view along line C-C′ of FIG. 6.

The gas provider 30 is a component for providing a gas to the burner 10. The gas provider 30 may include the gas valve 31 and the gas pipe 32. The gas valve 31 is coupled to the burner 10 to control flow of a gas transferred to the burner 10 to be used as fuel. The gas valve 31 may adjust a flow rate of the gas transferred to the burner 10 as an opening degree is adjusted. The flow rate of the gas transferred to the burner 10 may be adjusted to adjust the amount of heat generated by the burner 10.

The gas provider 30 may include a valve adapter 34. The valve adapter 34 may be coupled to a valve fixing portion 323 of the gas pipe 32 and the gas valve 31 to connect the gas pipe 32 to the gas valve 31. The gas provider 30 may include the transfer pipe 33. The transfer pipe 33 may connect the gas valve 31 to the blower of the burner 10 to transfer the gas passing through the gas valve 31 to the burner 10. The water heater 1 may include a valve support 90, and the valve support 90 may be fixed to an upper portion of the combustion chamber and support the gas valve 31 by seating the gas valve 31 thereon.

The gas pipe 32, which is a pipe for transferring the gas to the gas valve 31, is coupled to the gas valve 31 to transfer the gas to the gas valve 31.

The gas pipe 32 may include the body portion 321. The body portion 321 is a portion which extends in the left-right direction and in which a hollow 320 is formed such that the gas passes therethrough. When the body portion 321 is cut along a plane perpendicular to the left-right direction, the body portion 321 may have a straight profile on an upper side thereof, the straight profile extending in the front-rear direction that is one direction perpendicular to the left-right direction. In description using the first direction and the second direction, the body portion 321 extends in the first direction, and the body portion 321 is provided with the seating section 3211 having a straight profile extending the second direction that is one direction perpendicular to the first direction when the seating section 3211 is cut along a plane perpendicular to the first direction. The body portion 321 passes in the first direction to form the hollow 320. The gas may flow through the hollow 320. The hollow 320 is formed not only in the body portion 321 but also in the case fixing portion 322 and the valve fixing portion 323.

The case fixing portion 322 extends rearward from the body portion 321 toward the rear plate 54 of the case 50. The body portion 321 may include the valve fixing portion 323. The valve fixing portion 323 extends forward from the body portion 321. That is, the case fixing portion 322 may have a shape extending rearward from a rear end that is one end of the body portion 321, and the valve fixing portion 323 may have a shape extending forward from a front end that is the other end of the body portion 321. In the front-back direction, a length of the case fixing portion 322 may be greater than a length of the valve fixing portion 323.

The body portion 321 may include the side section 3212 having a straight profile extending in the vertical direction when the side section 3212 is cut along a plane perpendicular to the front-rear direction. In description using the first direction and the third direction, the body portion 321 may include the side section 3212 having a straight profile extending in the third direction that is perpendicular to the first direction and the second direction when the side section 3212 is cut along a plane perpendicular to the first direction. A total of a pair of side sections 3212 may be arranged one by one on left and right sides of the seating section 3211. The side sections 3212 may extend downward from left and right ends of the seating section 3211. The pair of side sections 3212 may each have a shape perpendicular to the left-right direction.

The body portion 321 may include a curved section 3213 that has a convex downward shape when the body portion 321 is cut along the plane perpendicular to the front-rear direction. The curved section 3213 may extend from a lower end of the side section 3212. The curved section 3213 may be positioned on a side opposite to the seating section 3211 in the vertical direction. The curved section 3213 may have a curved profile that is convex in a direction away from the seating section 3211. Thus, the body portion 321 may have a “D”-shaped profile when the body portion 321 is cut along the plane perpendicular to the front-rear direction. The body portion 321 may have a profile in which the side section 3212 connects the seating section 3211 and the curved section 3213.

A portion of the seating section 3211 may be passed through to define a mounting hole 3210. The mounting hole 3210 may be provided as a plurality of mounting holes 3210. The plurality of mounting holes 3210 may be spaced apart from each other in the front-back direction. A portion of the body portion 321 in which a guide groove 3215 is formed may be passed through to define the mounting hole 3210. A gas switch 80 may be coupled to the mounting hole 3210. The water heater 1 according to the embodiment of the present disclosure may include the gas switch 80. The body portion 321 may have the above-described profile, the mounting hole 3210 is formed in the seating section 3211 having a sufficient thickness “D,” and thus the gas switch 80 may be stably coupled to a sufficiently thick portion as compared to a case in which the mounting hole 3210 is formed to pass through a wall body of a curved circular pipe. Further, because the side section 3212 including a pair of portions is easily gripped with a chuck or the like, the mounting hole 3210 may be also stably processed.

In the gas pipe 32, a center of the seating section 3211 may be recessed in the front-rear direction based on the left-right direction to define the guide groove 3215. The guide groove 3215 may have a “V” shaped profile when the guide groove 3215 is cut along a plane perpendicular to the front-rear direction. The mounting hole 3210 may be formed in a portion in which the guide groove 3215 is positioned. The mounting hole 3210 is further formed in a portion in which the guide groove 3215 is formed, and thus, a position at which the mounting hole 3210 should be processed may be easily identified during the processing. Further, when the mounting hole 3210 is processed with a drill or the like, a tool may be easily guided to a correct position by the guide groove 3215. A cross-section along line B-B′ represents a shape of a portion at which a processing hole is positioned, and a cross-section along line C-C′ represents a shape of a portion of the body portion 321, in which the processing hole is not positioned.

The body portion 321 may have a front-rear side surface 3214 perpendicular to the front-rear direction at a boundary with the case fixing portion 322 or the valve fixing portion 323 but may also have the front-rear side surface 3214 inclined inward based on the front-rear direction in the vertical direction as illustrated. The front-rear side surface 3214 may be included inward based on the front-rear direction in the left-right direction.

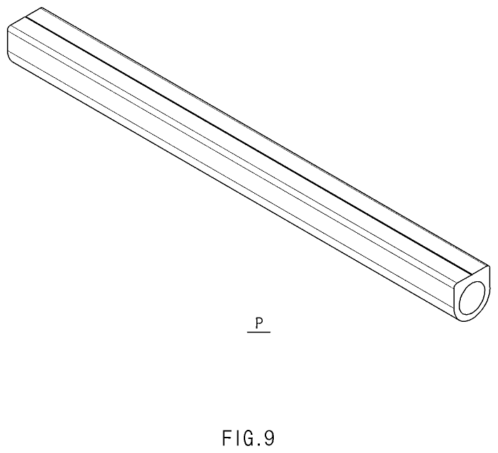

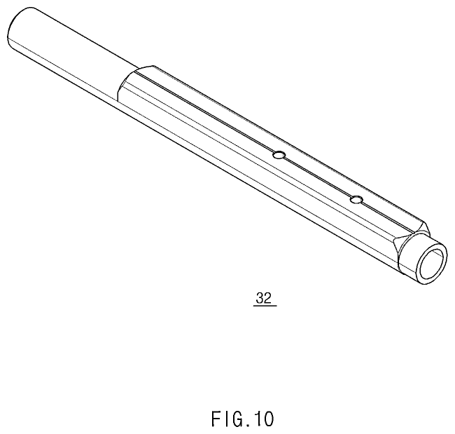

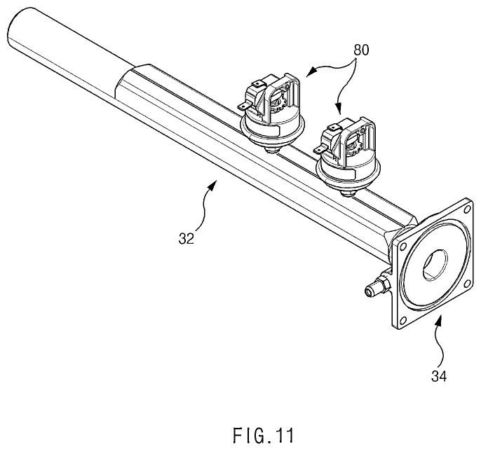

FIG. 9 is a perspective view illustrating a basic pipe “P” for forming the gas pipe 32 of the water heater 1 according to the embodiment of the present disclosure. FIG. 10 is a perspective view illustrating a state in which the gas pipe 32 is formed by processing the basic pipe “P” according to the embodiment of the present disclosure. FIG. 11 is a perspective view illustrating a state in which components for forming the gas provider 30 are connected to the gas pipe 32 according to the embodiment of the present disclosure.

Referring to FIG. 9, the water heater 1 according to the embodiment of the present disclosure may be formed from the basic pipe “P.” The basic pipe “P” may be formed by methods such as injection. The basic pipe “P” may be made of a metal but may also contain other materials. The basic pipe “P” may have a shape extending overall in the front-rear direction, have a “D”-shaped cross-sectional profile, and have the hollow 320. The guide groove 3215 may be formed in the basic pipe “P.”

Referring to FIG. 10, both ends of the basic pipe “P” may be processed to make the valve fixing portion 323 and the case fixing portion 322 having a shape such as a circular pipe. A through-hole may be formed by drilling a portion in which the guide groove 3215 is formed. This processing may be achieved by gripping and fixing the side sections 3212 with a chuck or gripping and fixing the seating section 3211 and the curved section 3213 with a chuck and then processing the sections with a drill or lathe. The gripping and fixing may be firmly performed by a shape of the basic pipe “P.”

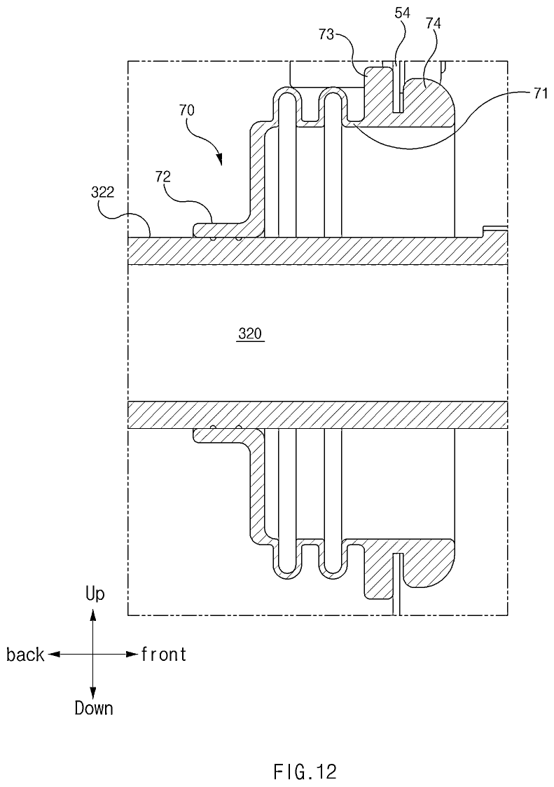

FIG. 12 is a cross-sectional view illustrating packing 70 and the gas pipe 32 in contact with the packing 70 according to the embodiment of the present disclosure.

The water heater 1 according to the embodiment of the present disclosure may include the packing 70. The packing 70 is coupled through the gas pipe through-hole formed in the rear plate 54 of the case 50, the case fixing portion 322 of the gas pipe 32 is coupled through the packing 70, and thus airtightness between the gas pipe 32 and the case 50 may be maintained. The packing 70 may be coupled to the gas pipe through-hole while surrounding the gas pipe 32, thereby filling a boundary between the gas pipe 32 and the rear plate 54. The packing 70 may be made of a flexible material to easily maintain the airtightness.

The packing 70 may include a large diameter packing body 71. The large diameter packing body 71 may have a corrugated shape and may be stretchable in the front-back direction. The large diameter packing body 71 may have an outer diameter corresponding to an inner diameter of the gas pipe through-hole and thus may serve to maintain airtightness between the gas pipe through-hole and the packing 70.

An external flange 73 protrudes radially outward from a body of the packing 70 outside the case 50, an internal flange 74 protrudes radially outward from the body of the packing 70 inside the case 50, and thus the rear plate 54 may be fixedly inserted between the external flange 73 and the internal flange 74. As illustrated, on a cross section, the external flange 73 may have a rectangular shape, and the internal flange 74 may have a shape that protrudes convexly radially outward and forward. Thus, when the packing 70 is fixedly inserted from the outside of the case 50 into the gas pipe through-hole, the internal flange 74 may serve to guide the insertion, and the external flange 73 may serve to prevent forward separation of the packing 70. A rear surface of the internal flange 74 may also serve to prevent rearward separation of the packing 70.

The packing 70 may include a small diameter packing body 72. The small diameter packing body 72 is connected to a rear end of the large diameter packing body 71, which is close to an outer portion of the case 50, has an inner diameter corresponding to an outer diameter of the case fixing portion 322 of the gas pipe 32, and thus may serve to maintain airtightness between the case fixing portion 322 and the small diameter packing body 72 when the case fixing portion 322 passes through the small diameter packing body 72.

Accordingly, according to the present disclosure, a gas switch or the like may be easily coupled from the outside of a pipe, and rotation may not be easy when the pipe is coupled to a support.

Hereinabove, even though it has been described that all components constituting the embodiments of the present disclosure are combined into one part or are operated while combined with each other, the present disclosure is not necessarily limited to these embodiments. That is, all the components may be operated while selectively combined into one or more parts within the scope of the present disclosure. Further, terms such as “includes”, “constitutes”, or “have” described above mean that the corresponding component may be inherent unless otherwise stated, and thus should be construed as not excluding other components but further including other components. All terms including technical or scientific terms have the same meanings as those commonly understood by those skilled in the art to which the present disclosure pertains unless otherwise defined. The generally used terms defined in the dictionaries should be construed as having the meanings that coincide with the meanings of the contexts of the related technologies and should not be construed as ideal or excessively formal meanings unless clearly defined in the present disclosure.

The above description is merely illustrative of the technical spirit of the present disclosure, and those skilled in the art to which the present disclosure belongs may make various modifications and changes without departing from the essential features of the present disclosure. Thus, the embodiments disclosed in the present disclosure are not intended to limit the technology spirit of the present disclosure, but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

What is claimed is:

1. A pipe comprising:
a body portion provided with a seating section having a straight profile extending in a first direction and extending in a second direction that is one direction perpendicular to the first direction when cut along a plane perpendicular to the first direction,
wherein the body portion passes in the first direction to define a hollow.

2. The pipe of claim 1, wherein the body portion is further provided with a side section having a straight profile extending in a third direction perpendicular to the first direction and the second direction when cut along the plane perpendicular to the first direction.

3. The pipe of claim 1, wherein the body portion is further provided with a curved section that is positioned on a side opposite to the seating section in a third direction perpendicular to the first direction and the second direction when cut along the plane perpendicular to the first direction and has a curved profile that is convex in a direction away from the seating section.

4. The pipe of claim 1, wherein the body portion has a “D”-shaped profile when cut along the plane perpendicular to the first direction.

5. The pipe of claim 1, wherein a portion of the seating section is passed through to define a mounting hole.

6. The pipe of claim 1, wherein a center of the seating section is recessed based on the second direction in the first direction to define a guide groove.

7. The pipe of claim 6, wherein a portion of the body portion in which the guide groove is formed is passed through to define a mounting hole.

8. The pipe of claim 6, wherein the guide groove has a “V”-shaped profile when cut along the plane perpendicular to the first direction.

9. The pipe of claim 1, further comprising:
a case fixing portion extending from one end of the body portion in the first direction; and
a valve fixing portion extending from the other end of the body portion.

10. The pipe of claim 9, wherein a length of the case fixing portion is greater than a length of the valve fixing portion in the first direction.

11. A water heater comprising:
a burner configured to cause a combustion reaction from fuel;
a heat exchanger configured to heat water using heat generated by the combustion reaction caused by the burner;
a gas provider including a gas valve coupled to the burner to control flow of a gas transferred to the burner to be used as fuel and a gas pipe coupled to the gas valve to transfer the gas to the gas valve; and
a case in which the burner, the heat exchanger, and the gas valve are embedded and which is coupled to the gas pipe,
wherein the gas pipe includes a body portion which extends in a left-right direction, in which a hollow is formed such that the gas passes therethrough, and which has a straight profile on an upper side thereof, the straight profile extending in a front-rear direction that t is one direction perpendicular to the left-right direction when cut along a plane perpendicular to the left-right direction.

12. The water heater of claim 11, wherein the gas pipe further includes a case fixing portion extending from the body portion to the case in the front-rear direction, and
wherein the water heater further includes a bracket coupled to the case and configured to support the case fixing portion.

13. The water heater of claim 12, wherein the bracket includes a bracket body part coupled to the case and a support bolt part which is coupled to the bracket body part and on which the case fixing portion is seated.

14. The water heater of claim 12, wherein the bracket is coupled to an inner surface of the case.

15. The water heater of claim 11, wherein a gas pipe through-hole through which the gas pipe passes is formed in the case, and
wherein the water heater further includes packing surrounding the gas pipe and coupled to the gas pipe through-hole such that airtightness between the gas pipe and the case is maintained.
